(19) United States
(12) Patent Application Publication
(10) Pub. No.: US 2016/0370738 A1
(43) Pub. Date: Dec. 22, 2016

(54) RECORDING MEDIUM CONVEYANCE GUIDE DEVICE, TRANSFER DEVICE, AND IMAGE FORMING APPARATUS

(71) Applicant: Takahiro Suzuki, Tokyo (JP)

(72) Inventor: Takahiro Suzuki, Tokyo (JP)

(73) Assignee: Ricoh Company, Ltd., Tokyo (JP)

(21) Appl. No.: 15/173,364

(22) Filed: Jun. 3, 2016

(30) Foreign Application Priority Data
Jun. 16, 2015 (JP) 2015121097
Feb. 5, 2016 (JP) 2016021029

(51) Int. Cl. G03G 15/16

(52) U.S. Cl. CPC G03G 15/1605

(57) ABSTRACT

A recording medium conveyance guide device includes a conveyance guide disposed upstream from a transfer nip to transfer an image to a recording medium in a recording-medium conveyance direction, to at least partially contact the recording medium. The recording medium conveyance guide device further includes a drive device to move a leading edge of the conveyance guide from a first position to a second position closer to the transfer nip than the first position when the trailing edge of the recording medium approaches the leading edge of the conveyance guide.

### CROSS-REFERENCE TO RELATED APPLICATIONS

This patent application is based on and claims priority pursuant to 35 U.S.C. §119(a) to Japanese Patent Application No. 2015-121097, filed on Jun. 16, 2015, and Japanese Patent Application No. 2016-021029, filed on Feb. 5, 2016 in the Japan Patent Office, the entire disclosure of each of which is hereby incorporated by reference herein.

### BACKGROUND

### Technical Field

Exemplary aspects of the present disclosure generally relate to a recoding medium conveying guide device, a transfer device, and an image forming apparatus, such as a copier, a facsimile machine, a printer, or a multi-functional system including a combination thereof.

### Related Art

There are some electrophotographic image forming apparatuses that include a conveyance guide at the upstream side of a transfer portion, which transfers a toner image from a belt-shape image bearer to a recording medium, in a direction of conveyance of recording medium, to guide a recording medium to the transfer portion. With such configuration that includes a conveyance guide upstream from the transfer portion, a recording medium is conveyed in a curved state due to the positional relation of the conveyance guide and the transfer portion. Accordingly, the trailing edge of the recording medium having just passed the conveyance guide collides against the belt-shaped image bearer, which is caused by the reaction of restoration of the recording medium, resulting in the toner image scattering.

Hence, a configuration is proposed that supports a conveyance guide to allow the conveyance guide to reciprocate along the directions that causes the conveyance guide to move close to and away from the belt-shaped image bearer by a drive source, such as a drive motor.

### SUMMARY

In an aspect of this disclosure, there is provided a recording medium conveyance guide device, including: a conveyance guide disposed upstream from a transfer nip to transfer an image to a recording medium in a recording-medium conveyance direction, the conveyance guide to at least partially contact the recording medium; and a drive device to move a leading edge of the conveyance guide from a first position to a second position closer to the transfer nip than the first position when a trailing edge of the recording medium approaches the leading edge of the conveyance guide.

In another aspect of this disclosure, there is provided a transfer device including the recording medium conveyance guide device described above.

In another aspect of this disclosure, there is provided a transfer device including an image forming apparatus having the transfer device described above.

### BRIEF DESCRIPTION OF THE DRAWINGS

The aforementioned and other aspects, features, and advantages of the present disclosure will be better understood by reference to the following detailed description when considered in connection with the accompanying drawings, wherein:

FIG. 1 is a schematic view of an image forming apparatus according to an embodiment of the present disclosure;

FIG. 2 is an enlarged view of a transfer device and a surrounding structure in the image forming apparatus of FIG. 1;

FIG. 3 is an enlarged view of a conveyance guide at an initial position and a recording sheet guided in a recording medium conveyance guide device according to an embodiment of the present disclosure;

FIG. 4 is an enlarged view of a conveyance guide at an operating position and a recording medium guided in the recording medium conveyance guide device according to an embodiment of the present disclosure;

FIG. 5A is a plan view of a configuration of the recording medium conveyance guide with the conveyance guide at the initial position according to an embodiment of the present disclosure;

FIG. 5B is a plan view of a configuration of the recording medium conveyance guide with the conveyance guide at the operating position according to an embodiment of the present disclosure;

FIG. 6 is a schematic diagram describing the positional relations of the conveyance guide at the initial position and the operating position, and the intermediate transfer belt;

FIG. 7 is a block diagram of a configuration of a control system in the recording medium conveyance guide device according to an embodiment of the present disclosure;

FIG. 8 is a schematic diagram describing a contact state of the recording medium guided by the conveyance guide and the intermediate transfer belt;

FIG. 9 is a schematic diagram describing a contact state of the recording medium and the intermediate transfer belt after the trailing edge of the recording medium passes the conveyance guide;

FIG. 10 is an enlarged view of a conveyance guide at an operating position in a recording medium conveyance guide device according to another embodiment;

FIG. 11 is an enlarged view of a conveyance guide at an operating position in a recording medium conveyance guide device according to another embodiment;

FIG. 12A is a schematic diagram describing a contact state of the recording medium guided by the conveyance guide and the intermediate transfer belt according to another embodiment;

FIG. 12B is a schematic diagram describing a contact state of the recording medium and the intermediate transfer belt after the trailing edge of the recording medium passes the conveyance guide according to another embodiment;

FIG. 13 is a view of a conveyance guide in a recording medium conveyance guide device according to another embodiment;

FIG. 14A is a view of a conveyance guide obliquely disposed according to one embodiment;

FIG. 14B is a view of another conveyance guide obliquely disposed according to another embodiment;

FIG. 15 is a perspective view of operation of the conveyance guide with the leading edge oblique;

FIGS. 16A and 16B are enlarged views of variations of the conveyance guide with the leading edge oblique;

FIG. 17 is a schematic diagram describing a speed of movement of the conveyance guide and a speed of conveyance of the recording medium; and

FIG. 18 is a schematic diagram describing the positional relations of the conveyance guide at the initial position and the operating position, and the intermediate transfer belt according to another embodiment.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In a configuration including a conveyance guide, the length of a contact portion between a recording medium and an image bearer after the trailing edge of the recording medium passed the conveyance guide tends to be longer than the length of the contact portion between the recording medium and the image bearer while the conveyance guide guides the recording medium to a secondary transfer nip. With an increase in length of the contact portion between the recording medium and the belt-shape image bearer, the time period of contact of the recording medium and the image bearer increases, thereby increasing the amount of flow of transfer bias supplied from a transfer portion to the recording medium. Accordingly, the electrical field at a secondary transfer nip increases, which increases the voltage applied to toner, resulting in transfer scattering that scatters toner of a toner image on the belt-shaped image bearer.

The above-described proposed configuration including the conveyance guide reduces the collision of the trailing edge against the belt-shaped image bearer because the conveyance guide moves close to the belt-shaped image bearer. However, it is difficult to reduce the occurrence of transfer scattering because there is no change in the time period of contact of the trailing edge of the recording medium and the image bearer.

According to at least one embodiment of the present disclosure to be described below, when the trailing edge of a recording medium approaches the leading edge of a conveyance guide, a drive device operates to move the leading edge of the conveyance guide from the first position to the second position closer to a transfer nip. Such configuration reduces the length of the contact portion between the trailing edge of the recording medium and an image bearer, thereby eliminating or reducing the occurrence of transfer scattering at the trailing edge of the recording medium.

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Although the embodiments are described with technical limitations with reference to the attached drawings, such description is not intended to limit the scope of the disclosure and all of the components or elements described in the embodiments of this disclosure are not necessarily indispensable.

Referring now to the drawings, embodiments of the present disclosure are described below. In the drawings for explaining the following embodiments, the same reference codes are allocated to elements (members or components) having the same function or shape and redundant descriptions thereof are omitted below.

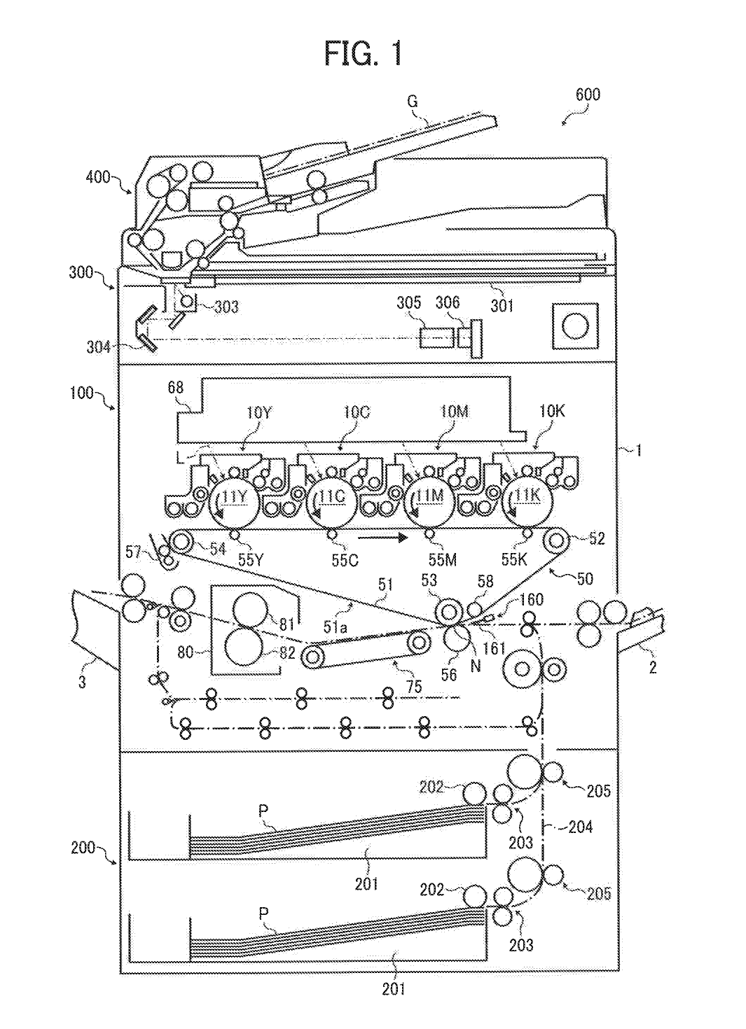

Referring to FIG. 1, a description is provided of an image forming apparatus 600 according to an embodiment of the present disclosure. The same reference numerals will be given to constituent elements such as parts and materials having the same functions, and the descriptions thereof will be omitted. In some Figures, portions of configurations are partially omitted to better understand the configurations. It is to be noted that suffixes Y, M, C, and K denote colors yellow, magenta, cyan, and black, respectively. These suffixes may be omitted unless otherwise specified.

FIG. 1 is a schematic view of an example of a multicolor copier 600 (herein after referred to as an image forming apparatus 600) as an electrophotographic image forming apparatus according to an embodiment of the present disclosure. The image forming apparatus 600 includes a printer unit 100, a sheet feeder 200, a scanner 300, and an automatic document feeder (ADF) 400. The printer unit 100 forms an image on a recording sheet P as a recording medium. The sheet feeder 200 feeds the recording sheet P to the printer unit 100. The scanner 300 reads out an image of document G. The ADF 400 automatically feeds the document G to the scanner 300.

In the scanner 300, a first moving body 303 including a light source and a mirror and a second moving body 304 including a plurality of reflection mirrors move from right to left and vice versa, reading out the document G placed on a contact glass 301. The second moving body 304 sends out scanning light through an image-forming lens 305 to an image-forming surface of a reading sensor 306 disposed backward of the image-forming lens 305, thereby collecting the scanning light on the image-forming surface. Then, the reading sensor reads in the scanning light as an image signal.

The printer unit 100 includes a bypass tray 2 and an output tray 3 on either side of an apparatus body 1. Onto the bypass tray 2, the recording sheet P to be fed into the apparatus body 1 is manually placed. Multiple recording sheets P having images formed are stacked on the output tray 3 after output from the apparatus body 1.

The sheet feeder 200 includes a plurality of sheet feeding trays 201 and 201, a sheet feeding roller 202 and a separation roller 203, and a conveyance roller 205. A stack of the recording sheets P are stored in each of the sheet feeding trays 201 and 201. The sheet feeding roller 202 and the separation roller 203 sends each recording sheet P out of the sheet feeding trays 201 and 201 to the conveyance path 204. The conveyance roller 205 conveys the recording sheet P in the conveyance path 204. The conveyance path 204 extends to a secondary transfer nip N to be described later, which conveys the recording sheet P to the secondary transfer nip N.

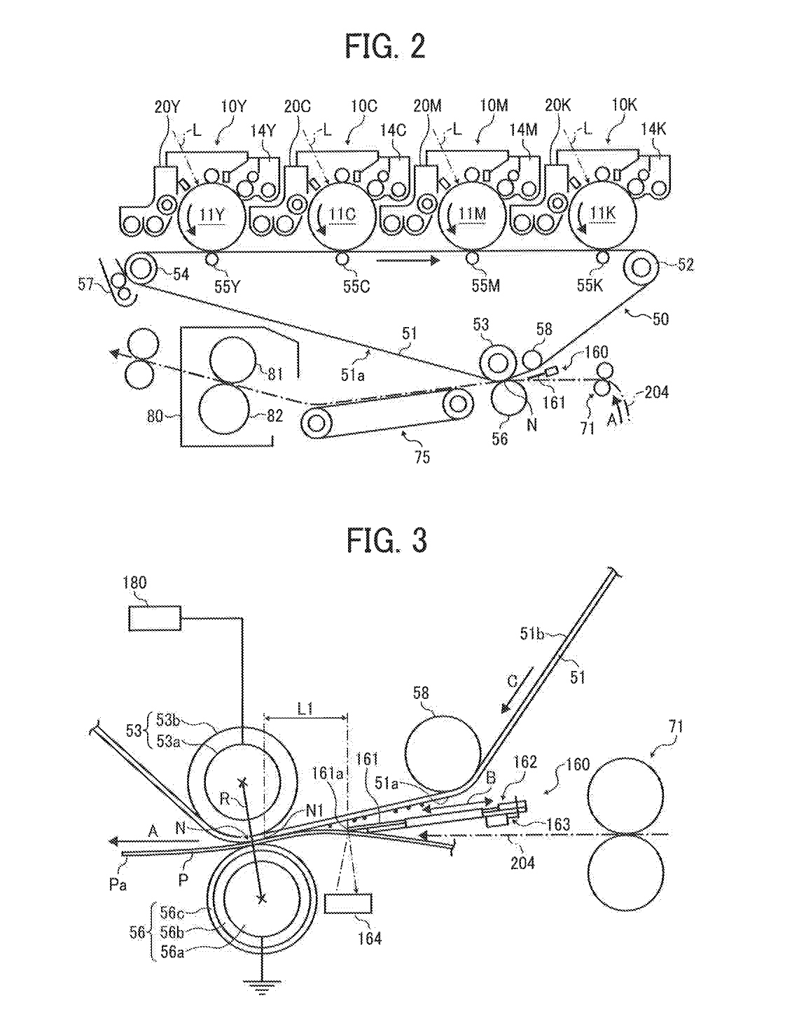

FIG. 2 is a partial enlarged view of a configuration of the printer unit 100. The printer unit 100 includes a transfer unit 50 as a transfer device. The transfer unit 50 includes an intermediate transfer belt 51 as a belt-shaped image bearer and also as an endless looped intermediate transferor, and a plurality of support rollers, such as a drive roller 52, a secondary-transfer first roller 53, a driven roller 54, and primary transfer rollers 55Y, 55C, 55M, and 55K as a primary transfer device, which of the support rollers stretch taut the intermediate transfer belt 51. The drive roller 52 is rotated in the counterclockwise direction by a drive device, and rotation of the drive roller 52 allows the intermediate transfer belt 51 to endlessly rotate in the same direction.

The intermediate transfer belt 51 is stretched taut between the support rollers such that the inter mediate transfer belt 51 is significantly curved at positions at which the respective the secondary-transfer first roller 53 and the driven roller 54 entrains the intermediate transfer belt 51, forming an inverted triangle shape with the base facing upward in the vertical direction. The base of the inverted triangle shape, which corresponds to the upper side of the looped intermediate transfer belt 51 extends in the horizontal direction. Above the upper side of the looped intermediate transfer belt 51, process units 10Y, 10C, 10M, and 10K as image forming units are horizontally disposed along the direction, in which the upper side of the intermediate transfer belt 51 extends. The process units 10Y, 10C, 10M, and 10K include drum-shaped photoconductors 11Y, 11C, 11M, and 11K as image bearers, respectively.

As illustrated in FIG. 1, an optical writing unit 68 is disposed above the process units 10Y, 10C, 10M, and 10K. The optical writing unit 68, based on image data of the document G read by the scanner 300, emits four laser beams L onto the respective photoconductors 11Y, 11C, 11M, and 11K with four semiconductor lasers driven by a laser controller, forming electrostatic latent images Y, C, M, and K on the surfaces of the photoconductors 11Y, 11C, 11M, and 11K. In the present embodiment, the laser beams emitted from the semiconductor lasers are reflected by a reflection mirror to pass through an optical lens, while being deflected by a polygon mirror. Thus, the optical writing unit 68 optically scans the photoconductors 11Y, 11C, 11M, and 11K. Alternatively, the optical writing unit 68 may employ an LED array.

The process units 10Y, 10C, 10M, and 10K includes cleaners 14Y, 14C, 14M, and 14K, charging devices, and developing devices 20Y, 20C, 20M, and 20K around the photoconductors 11Y, 11C, 11M, and 11K. In each of the process units 10Y, 10C, 10M, and 10K, the surface of each photoconductor 11Y, 11C, 11M, or 11K is uniformly charged by each charging device. The charged surface of the photoconductor 11Y, 11C, 11M, or 11K is irradiated with the laser beam L to form an electrostatic latent image on the surface of each photoconductor 11Y, 11C, 11M, or 11K. The electrostatic latent image on each photoconductor 11Y, 11C, 11M, or 11K is developed with toner of each color by the corresponding developing device 20Y, 20C, 20M, or 20K. Accordingly, a toner image of each color Y, C, M, or K is formed.

Referring to FIG. 2, the photoconductors 11Y, 11M, 11C, and 11K contact the upper side surface of the intermediate transfer belt 51to form primary transfer nips between each of the photoconductors 11Y, 11M, 11C, and 11K and the intermediate transfer belt 51. The photoconductors 11Y, 11M, 11C, and 11K are driven to endlessly rotate in a counterclockwise direction while contacting the the front surface of the intermediate transfer belt 51. The primary transfer rollers 55Y, 55C, 55M, and 55K contacts the back surface of the intermediate transfer belt 51. The respective primary transfer rollers 55Y, 55C, 55M, and 55K receive a transfer bias having a polarity opposite to the charging polarity of toner. Thus, at the secondary transfer nip is formed a secondary-transfer electric field that electrostatically moves toner from the intermediate transfer belt 11 toward the secondary-transfer second roller 56 by electrostatic force.

The toner images of colors Y, C, M, and K formed on the photoconductors 11Y, 11C, 11M, and 11K enter the corresponding primary transfer nip with the rotation of the photoconductors 11Y, 11C, 11M, and 11K. The toner images Y, C, M, and K are sequentially transferred onto the intermediate transfer belt by the primary transfer electrical field and nip pressure. Thus, a composite four-color toner image (hereinafter, referred to as four-color toner image) is formed on the front surface 51a (the circumferential surface of the loop) of the intermediate transfer belt 51. The intermediate transfer belt 51 bears an image to be transferred onto the recording sheet P. It should be noted that, instead of the primary transfer rollers 55Y, 55C, 55M, and 55K, a conductive brush to receive the primary transfer bias, or a non-contact corona charger may be adopted in some embodiments.

Outside the loop of the intermediate transfer belt 51, a secondary-transfer second roller 56 as a transfer device is opposed to the secondary-transfer first roller 53, contacting the front surface 51a of the intermediate transfer belt 51. The secondary-transfer second roller 56 contacts the intermediate transfer belt 51 to form a secondary transfer nip N as a transfer portion between the secondary-transfer second roller 56 and the intermediate transfer belt 51, in which the four-color toner image is transferred from the intermediate transfer belt 51 onto the recording sheet P. It should be noted that arrow A in FIG. 2 refers to a direction of conveyance of the recording sheet P (hereinafter, referred to as a recording-medium conveyance direction A). Outside the loop of the intermediate transfer belt 51, a belt cleaner 57 is disposed at a position opposed to the driven roller 54. The belt cleaner 57 scrapes the remaining toner and powder off the front surface 51a of the intermediate transfer belt 51.

As illustrated in FIG. 2, the conveyance path 204 disposed upstream of the secondary transfer nip N in the recording-medium conveyance direction A includes a registration roller pair 71 and a recording medium conveyance guide device 160. The registration roller pair 71 sends out the recording sheet P conveyed through the conveyance path 204 to the secondary transfer nip N, timed to coincide with the arrival of the four-color toner image. The recording medium conveyance guide 160 guides the recording sheet P to the secondary transfer nip N.

A conveyance device 75 and a fixing device 80 are disposed downstream from the secondary transfer nip N in the recording-sheet conveyance direction A. The conveyance device 75 conveys the recording sheet P having passed through the secondary transfer nip N. In the fixing device 80, a fixing roller 81 contacts a pressure roller 82 to form a fixing nip between the pressure roller 82 and the fixing roller 81, in which the toner image of the recording sheet P is fixed on the recording sheet P with heat and pressure (i.e., a fixing process).

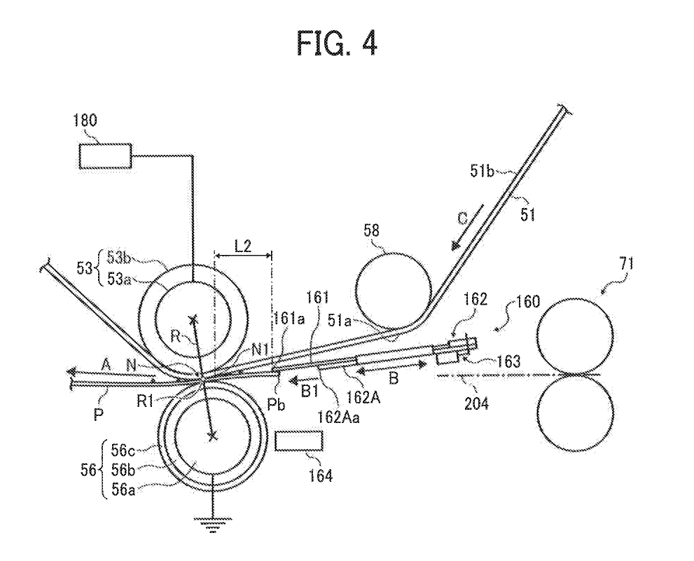

As illustrated in FIGS. 3 and 4, the secondary-transfer second roller 56 includes a cylindrical core metal 56a made of a metal, a conductive elastic layer 56b covering the outer circumferential surface of the core metal 56a, and a surface layer 56c covering the outer circumferential surface of the elastic layer 56b, which constitute an elastic roller. The secondary-transfer first roller 53 includes a cylindrical core metal 53a made of a metal and a conductive elastic layer 53b covering the outer circumferential surface of the core metal 53a, which constitute an elastic roller. The secondary-transfer second roller 56 presses against the secondary-transfer first roller 53 via the intermediate transfer belt 51 to form the secondary transfer nip N.

In the present embodiment, the secondary-transfer first roller 53 receives a secondary transfer bias having the same polarity as that of toner from a secondary transfer power source 180. Further, the secondary-transfer second roller 56 is electrically grounded. With this configuration, the secondary transfer bias mainly flows through a path R connecting between the axis of the secondary-transfer first roller 53 and the axis of the secondary-transfer second roller 56, thereby transferring transfers the toner image onto the recording sheet P passing through the secondary transfer nip N. That is, the toner image is secondarily transferred from the intermediate transfer belt 51 onto the recording sheet P at a position of the path R (hereinafter, referred to as an inter-axis position) connecting the axes of the rollers 53 and 56.

When a gap is formed upstream in the direction of movement of the intermediate transfer belt 51 (which is hereinafter referred to as a belt moving direction C) between the front surface 51a of the intermediate transfer belt 51 and the secondary-transfer second roller 56, the electrical discharge occurs in the gap. Such electrical discharge scatters toner in the toner image on intermediate transfer belt 51 before the entrance of the secondary transfer nip N, thereby causing transfer scattering.

In view of the circumferences described above, in the present embodiment, a pressing roller 58 as a pressing device is disposed upstream from the secondary transfer nip N in the recording-medium conveyance direction A, within the loop of the intermediate transfer belt 51, so as to form a gap at a position away from the inter-axis position. The pressing roller 58 in contact with the back surface 51b of the intermediate transfer belt 51 presses down the intermediate transfer belt 51 against the secondary-transfer second roller 56. Such press down forces the intermediate transfer belt 51 to be wound around the surface (the surface layer 56c) of the secondary-transfer second roller 56 at the upstream side from the inter-axis position in the recording-medium conveyance direction A. Pressing down the pressing roller 58 in such a manner forms a pre-nip between the intermediate transfer belt 51 and the secondary-transfer second roller 56, at the upstream side from the inter-axis position in the recording-medium conveyance direction A. In the present embodiment, with such a prenip formed, the area of the secondary transfer nip N increases toward upstream in the belt moving direction C, preventing a gap from being formed at a position where the secondary transfer current flows, thus forming a gap away from the position where the secondary transfer current flows. As a result, the occurrence of transfer scattering is effectively prevented particularly around the leading edge Pa of the recording sheet P.

### First Embodiment

Next, a description is given of the recording medium conveyance guide device 160. As illustrated in FIGS. 3 and 4, the recording medium conveyance guide device 160 includes a conveyance guide 161, a support 162, a drive device 163, and a recording medium detector 164. The conveyance guide 161 partially contacts a recording sheet P as a recording medium. The support 162 supports the conveyance guide 161 to allow the conveyance guide 161 to linearly slide in a direction indicated by arrow B that moves the conveyance guide 161 close to and moves the conveyance guide 161 away from a secondary transfer nip N (hereinafter referred to as a direction B). The drive device 163 slides the conveyance guide 161 along the direction B. The recording medium detector 164 detects a position of the recording sheet P during conveyance.

The recording medium detector 164 as an optical sensor emits light and receives a reflected light from the recording sheet P to detect a position of the recording sheet P. The recording medium detector 164 is disposed between the registration roller pair 71 and the secondary transfer nip N, and preferably below a position of a leading edge 161a of the conveyance guide 161 at the initial position as the first position, with the conveyance path 204 intervened between the leading edge 161a and the recording medium detector 164. With such disposition, the recording medium detector 164 detects a position of the recording sheet P fed out by the registration roller pair 71.

The support 162 includes a support plate 162A and a spring 162B as a biasing device with both ends connected to the support 162A and the conveyance guide 161, respectively. The support plate 162A extends toward the secondary transfer nip N to support the conveyance guide 161. The spring 162B biases the conveyance guide 161 toward a direction to move the conveyance guide 161 away from the secondary transfer nip N (hereinafter, referred to as a direction B2).

The support plate 162A is disposed upstream from the leading edge 161a of the conveyance guide 161 in the recording-medium conveyance direction A, having a leading edge 162Aa that contacts the recording sheet P to guide the recording sheet P to the secondary transfer nip N. That is, the support plate 162A also works as a guide. The support plate 162A is made of a sheet metal or resin, for example, that does not easily flex as compared to the conveyance guide 161.

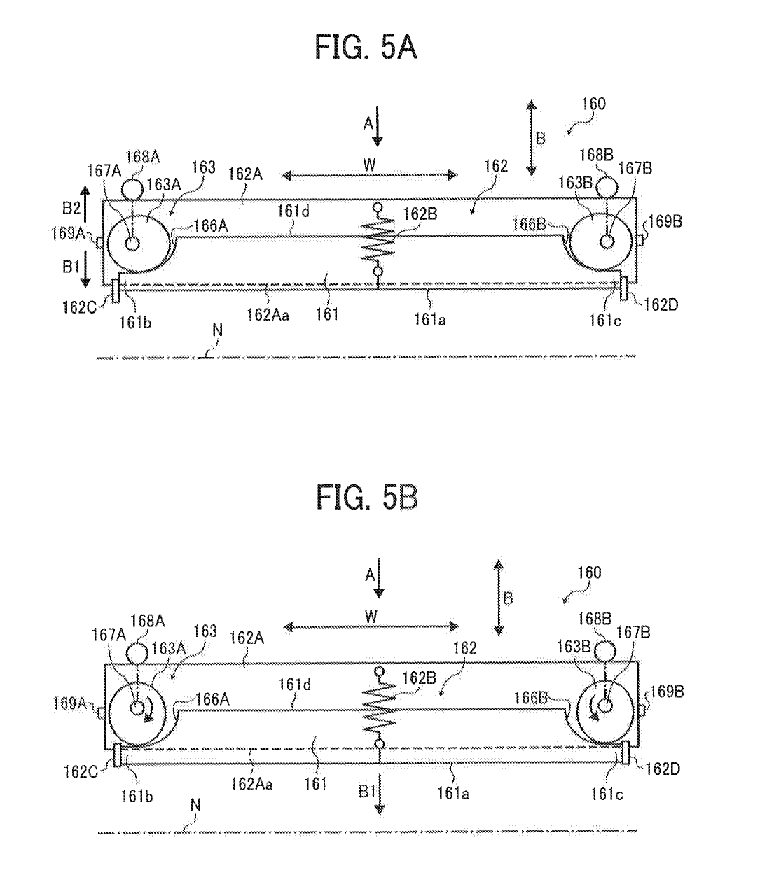

As illustrated in FIGS. 5A and 5B, the conveyance guide 161 is a film member, such as Mylar (registered trademark), extending in a width direction W perpendicular to the recording-medium conveyance direction A from the planar view. The conveyance guide 161 is laminated on the support plate 162A of the support 162, to slide along the direction B. The width of the conveyance guide in the direction W is longer than the width of the recording sheet P. As illustrated in FIG. 3, the length of the conveyance guide 161 in the recording-medium direction A includes the length of protrusion of the leading edge 161a from the leading edge 162Aa of the support plate 162A at the initial position (the first position) to the secondary transfer nip N.

The support plate 162A supports the conveyance guide 161, allowing the conveyance guide 161 at the initial position as the first position of FIG. 3 to slidably move in a direction B1 to approach the secondary transfer nip N (hereinafter, referred to as a “direction B1”), projecting farther forward to reach an operating position as a second position as illustrated in FIG. 4.

The initial position (first position) of the conveyance guide 161 refers to a position of the leading edge 161a sufficiently away from the entrance N1 of the secondary transfer nip N, at which no electrical discharge occurs between the leading edge Pa of the recording sheet P and the intermediate transfer belt 51. That is, “the initial position” refers to the position of the leading edge 161a, at which the distance from the entrance N1 of the secondary transfer nip N to the leading edge 161a is L1 as illustrated in FIG. 3. The operating position as the second position of the conveyance guide 161 refers to a position of the leading edge 161a, at which the distance from the entrance N1 to the leading edge 161a is L2, as illustrated in FIG. 4. L2 is shorter than L1. Preferably, the conveyance guide 161 before contacting the recording sheet P is oriented to a position within the range of ±5 mm in a line direction from the point R1 at the intersection of the front surface 51a of the intermediate transfer belt 51 with the line connecting between the center of repulsive force and the center of the secondary transfer nip N. In the present embodiment, the conveyance guide 161 is oriented to the point R1. In the present embodiment, although the line described above is positioned on the path R, the line may not be on the path R.

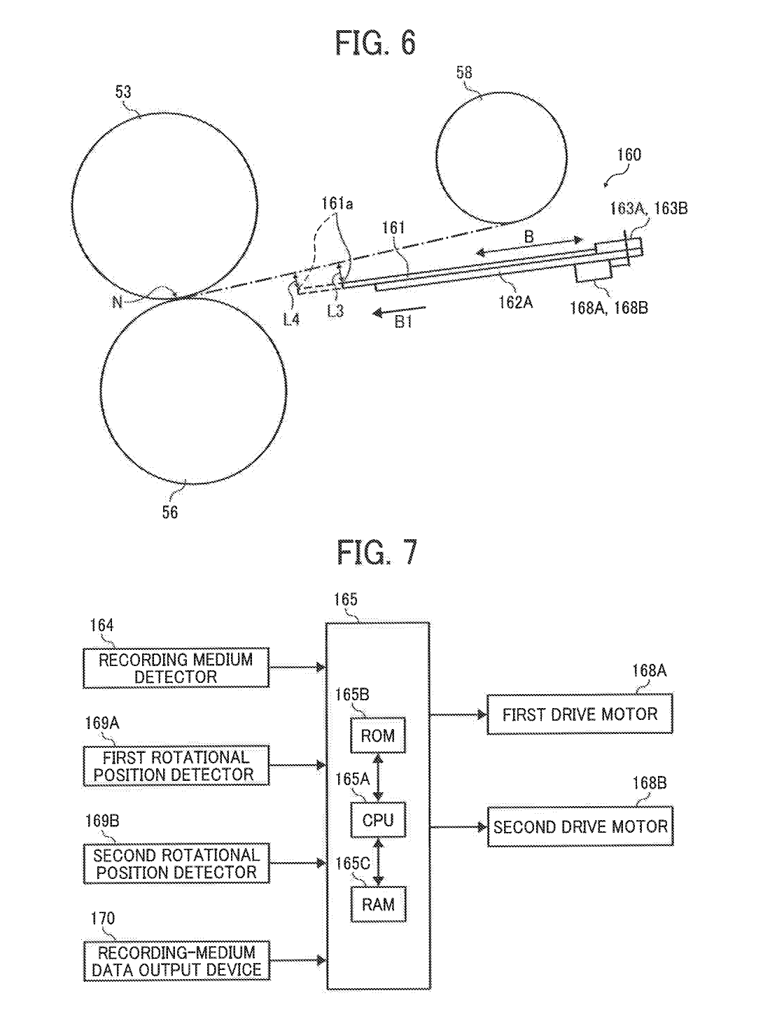

In the present embodiment, as illustrated in FIG. 6, the conveyance guide 161 is inclined relative to the running track of the intermediate transfer belt 51 before the entrance of the secondary transfer nip N. The running track is indicated by a chain line. The distance from the running track to the position of the leading edge 161a of the conveyance guide 161 at the operating position (the second position) indicated by a broken line is L4. The distance from the running track to the position of the leading edge 161a of the conveyance guide 161 at the initial position (the first position) indicated by a solid line is L3. L4 is shorter than L3. That is, the distance between the intermediate transfer belt 51 and the position of the leading edge 161a of the conveyance guide 161 slided toward the secondary transfer nip N is shorter than the distance between the intermediate transfer belt 51 and the position of the leading edge 161a of the conveyance guide 161 before sliding.

In FIGS. 5A and 5B, the conveyance guide 161 has first and second ends 161b and 161c in the width direction W. The first ends 161b and the second end 161c are slidably supported by guide portions 162C and 162D disposed on the support plate 162A. The guide portions 162C and 162D restrict the movement of the first and second ends 161b and 161c in the width direction W. Hereinafter, the end 161b and the end 161c are referred to as a first end 161b and a second end 161c of the conveyance guide 161 in the width direction W perpendicular to the recording-medium conveyance direction A.

The conveyance guide 161 further includes a trailing edge 161d disposed at the opposite side of the leading edge 161a. The trailing edge 161d has contact portions 166A and 166B formed on both sides, to contact the outer circumferential surfaces as cam surfaces of eccentric cams 163A and 163B that constitute drive devices 163. Each of the contact portions 166A and 166B is concave from the trailing edge 161d toward the leading edge 161a, which allows substantially halves of the respective eccentric cams 163A and 163B to be housed within the projected area of the conveyance guide 161. With this configuration, the total length of the recording medium conveyance guide device 160 in the recording-medium conveyance direction A is reduced, facilitating the disposition of the recording medium conveyance guide device 160 at the upstream side of the secondary transfer nip N where there is little space. In the case that there is sufficient space upstream from the secondary transfer nip N, instead of the configuration with concave contact portions 166A and 166B, a configuration with the eccentric cams 163A and 163B contacting the trailing edge 161d is applicable.

The eccentric cams 163A and 163B are rotatably supported on the support plate 162A by shaft 167A and 167B, respectively. The shafts 167A and 167B are connected with drive motors 168A and 168B as drivers, respectively. The drive device 163 includes the drive motors 168A and 168B. A stepping motor is employed as the drive motors 168A and 168B, for example. In the present embodiment, the drive motors 168A and 168B are mounted on the support plate 162A, thereby forming a single unit.

The eccentric cams 163A and 163B of the same cam shape are disposed on the support plate 162A in line symmetry relative to each other. In this configuration, the eccentric cam 163A is driven by the drive motor 168A to rotate in an opposite direction to that of the eccentric cam 163B driven by the drive motor 168B. With the eccentric cams 163A and 163B at the top dead center, the length from the entrance N1 to the leading edge 161a of the conveyance guide 161 at the operating position (the second position) is L2, as illustrated in FIG. 4. The sufficient amount of movement (slide) of the conveyance guide 161 is secured to allow the leading edge 161a to move to a position, at which the distance from the entrance N1 to the leading edge 161a is L2. That is, the conveyance guide 161 slidably moves both in the direction B1 and the direction B2 by the rotation of the eccentric cams 163A and 163B as cams for restricting the position of the conveyance guide 161 and by the pressing force of the spring 162B.

In the present embodiment, the conveyance guide 161 is disposed on the support plate 162A in such a manner that the amounts of protrusion of the leading edge 161a from the leading edge 162Aa of the support plate 162A are the same at between the first end 161 b and the second end 161c. That is, in the present embodiment, the leading edge 161a of the conveyance guide 161 is parallel to the leading edge 162Aa of the support plate 162A. The leading edge 161a and the leading edge 162Aa are disposed perpendicular to the recording- medium conveyance direction A.

A first rotational position detector 169A and a second rotational position detector 169B detect the rotational positions of the eccentric cams 163A and 163B, respectively. The first rotational position detector 169A and the second rotational position detector 169B detect the rotational positions of the eccentric cams 163A and 163B having moved the conveyance guide 161 to the second position and the rotational positions of the eccentric cams 163A and 163B having moved the conveyance guide 161 to the first position, to output the detected rotational positions to the controller 165.

In the recording medium conveyance guide device 160 according to the present embodiment, the drive device 163 operates to move the conveyance guide 161 from the first position of FIG. 3 to the second position of FIG. 4, at which the leading edge 161a comes closer to the secondary transfer nip N as the transfer portion than the first position does, when the trailing edge Pb of the recording sheet P detected by the recording medium detector 164 approaches the leading edge 161a.

In this case, the first and second drive motors 168A and 168B of the drive device 163, the recording medium detector 164, and the first and second rotational position detectors 169A and 169B are connected with the controller 165 via signal lines, as illustrated in FIG. 7.

The drive device 163 slides the conveyance guide 161 relative to the support 162 to allow the leading edge 161a of the conveyance guide 161 to move between the initial position as the first position and the operating position as the second position.

The controller 300 includes a central processing unit (CPU) 165A as a computing device, a read only memory (ROM) 165B as a nonvolatile memory, and a random access memory (RAM) 165C as a temporary storage device. The controller 165 judges the position of the recording sheet P based on the data detected by the recording medium detector 164, to control the first drive motor 168A and the second drive motors 168B to rotate when the trailing edge Pb of the recording sheet P approaches the leading edge 161a of the conveyance guide 161. With the rotation of the first drive motor 168A and the second drive motors 168B, the eccentric cam 163A and the eccentric cam 163B rotate in synchronization with each other. The controller 165 controls the drive motors 168A and 168B to stop rotating in response to the rotational position corresponding to the second position detected by the rotational position detectors 169A and 169B.

That is, the controller 165 calculates the length of time it takes for the trailing edge Pb of the recording sheet P to reach the leading edge 161a in response to the detection of the leading edge Pa of the recording sheet P at the upstream side of the secondary transfer nip N in the recording-medium conveyance direction A. Then, the controller 165 controls the drive device 163 to move and extend the conveyance guide 161 from the first position of FIG. 3 toward the direction B1, and to the second position of FIG. 4 when the trailing edge Pb of the recording sheet P approaches the leading edge 161a of the conveyance guide 161. FIG. 7 also illustrates another configuration according to another embodiment, in which the controller 165 works as a controller 165 for each embodiment.

It should be noted that, in the present embodiment, the first rotational position detector 169A and the second rotational detector 169B detect the rotational positions of the eccentric cams 163A and 163B, respectively. When stepping motors are employed for the first and second drive motors 168A and 168B, the rotational positions of the eccentric cams 163A and 163B are detected by the number of steps of the stepping motors, which means no first and second rotational position detectors 169A and 169B are employed.

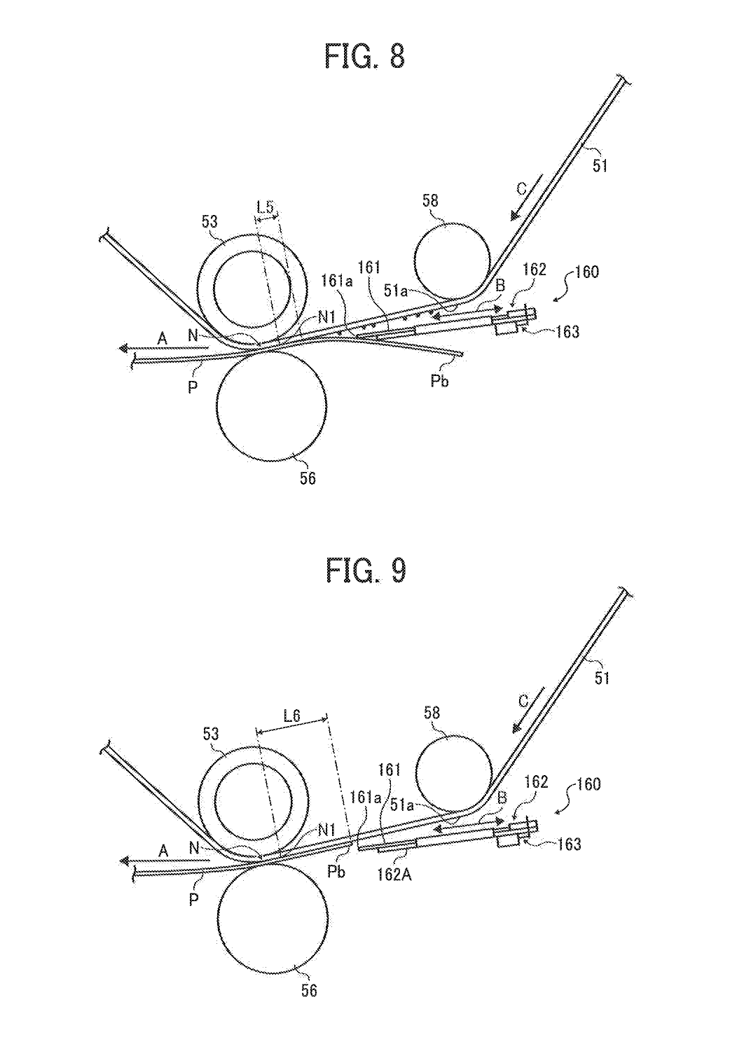

Next, a description is provided of transfer scattering that occurs at the trailing edge Pb of the recording sheet P having passed through the conveyance guide 161, referring to FIGS. 8 and 9.

During conveyance, the recording sheet P is guided to the secondary transfer nip N, contacting the leading edge 161a of the conveyance guide 161 and the leading edge 162Aa of the support plate 162A, as illustrated in FIG. 8. After the trailing edge Pb of the recording sheet P passes through the conveyance guide 161, the upper surface of the recording sheet P comes in contact with the front surface 51 of the intermediate transfer belt, traveling to the secondary transfer nip N. During this time, the length of contact between the recording sheet P and the intermediate transfer belt 51 is longer than the length of a contact portion between the recording sheet P and the conveyance guide 161 or the support plate 162A. The length of contact between the intermediate transfer belt 51 and the recording sheet P contacting the conveyance guide 161 or the support plate 162A is L5, as illustrated in FIG. 8. The length of a contact portion between the intermediate transfer belt 51 and the recording sheet P with the trailing edge Pb having passed through and separated from the conveyance guide 161 and the support plate 162A is L6. L5 is shorter than L6, as illustrated in FIG. 9. In this case, the electrical field increases at the trailing edge Pb of the recording sheet P, thereby increasing a voltage applied to a toner image electrostatically bored on the front surface 51a of the intermediate transfer belt 51, resulting in scattering the toner image. That is, increasing the electrical field at the trailing edge Pb of the recording sheet P easily generates the electrical discharge, which causes transfer scattering.

In view of the circumstances described above, in the present embodiment, the recording medium conveyance guide device 160 is disposed at the upstream side from the secondary transfer nip N in the recording-medium conveyance direction A, as illustrated in FIG. 4. The recording medium conveyance guide device 160 includes the conveyance guide 161 that linearly slides and moves along the direction B to the secondary transfer nip N. The conveyance guide 161 is at the first position (the initial position) before the recording medium detector 164 detects the trailing edge Pb of the recording sheet P. When the trailing edge Pb of the recording sheet P passes through the conveyance guide 161, the first drive motor 168A and the second drive motor 168B are driven to rotate the eccentric cams 163A and 163B, moving the conveyance guide 161 toward the secondary transfer nip N.

This delays the exit of the trailing edge Pb of the recording sheet P from the leading edge 161a of the conveyance guide 161, shortening the length L6 of a contact portion between the intermediate transfer belt 51 and the trailing edge Pb of the recording sheet P as compared to the configuration, in which the conveyance guide 161 does not slide and move to the secondary transfer nip N. That is, extending the conveyance guide 161 toward the secondary transfer nip N extends the length of time it takes for the conveyance guide 161 to support the trailing edge Pb of the recording sheet P.

This prevents an increase in the electrical field at the trailing edge Pb of the recording sheet P, reducing the voltage applied to the toner image electrostatically bored on the front surface 51a of the intermediate transfer belt 51, which prevents the occurrence of the electrical discharge. As a result, transfer scattering that scatters the toner image at the trailing edge Pb of the recording sheet P is prevented.

### Second Embodiment

The recording sheet P curls differently depending on the type and thickness of the recording sheet P, during conveyance. This means that the trailing edge Pb of the recording sheet P comes in contact with the intermediate transfer belt 51 with a different strength after passing the leading edge 161a of the conveyance guide 161, depending on the type and thickness of the recording sheet P. With the recording sheet P strong in stiffness, such as thick paper, a restoring force to restore to a linear state is stronger than the recording sheet P weak in stiffness, such as thin paper. With such paper having a strong restoring force, toner on the front surface 51a of the intermediate transfer belt 51 easily scatters when the trailing edge Pb of the recording sheet P contacts the intermediate transfer belt 51.

In the present embodiment, as illustrated in FIG. 7, a recording-medium data output device 170, which is connected to the controller 165 via a signal line, outputs data regarding the thickness and stiffness of the recording sheet P. In response to data regarding the recording sheet P output from the recording-medium data output device 170, the controller 165 changes the operating position of the conveyance guide 161. That is, with data (the value of the thickness or stiffness of the recording sheet P) output from the recording-medium data output device 170 greater than a predetermined value, the controller 165 controls the first drive motor 168A and the second drive motor 168B to operate such that the distance L1 from the entrance N1 of the nip N to the leading edge 161a is shorter than the distance from the entrance N1 to the leading edge 161a in the case that data (the values of the thickness and stiffness of the recording sheet P) is not greater than the predetermined value. The case, in which data is not greater than the predetermined value refers to the case, in which the stiffness of the recording sheet P is lower than a predetermined stiffness, or the thickness of the recording sheet P is lower than a predetermined thickness. The case, in which data is greater than the predetermined value, refers to the case, in which the stiffness of the recording sheet P is greater than a predetermined stiffness, or the thickness of the recording sheet P is greater than a predetermined thickness. “Stiffness” is specified by Clark stiffness method according to JISP8143. Preferably, the values of thickness and stiffness of sheets are previously measured for each type of sheets, and stored in the recording-medium data output device 170. The recording-medium output device 170 preferably outputs data regarding the thickness and stiffness of a sheet selected by a user according to the type of the sheet selected. Alternatively, in response to the type of a sheet detected by the recording medium detector 164, the recording-medium output device 170 outputs data regarding the thickness and stiffness of the sheet detected. With any configuration described above, variable operations of the conveyance guide 161 according to the output data regarding the recording sheet P is easily performed.

It should be noted that, instead of the configuration, in which the values of the thickness and stiffness of the recording sheet P are previously stored in the recording-medium data output device 170, a configuration is applicable, in which a device, such as the recording medium detector 164, directly detects the values of the thickness and stiffness of the recording sheet P. In this case, the occurrence of transfer scattering at the trailing edge Pb is reliably prevented for each recording sheet P conveyed.

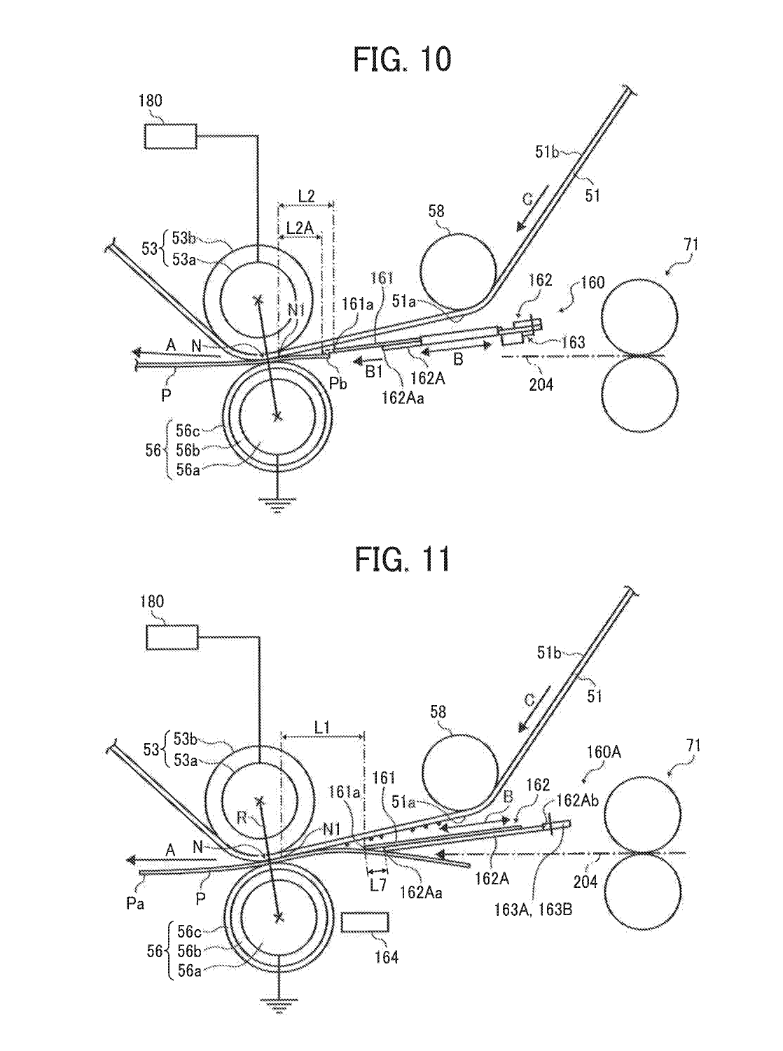

For example, in the present embodiment, with data from the recording-medium data output device 170 greater than the predetermined value, the conveyance guide 161 moves such that the distance from the entrance N1 to the leading edge 161a is L2A, which is shorter than the distance L2 described in the first embodiment, as illustrated in FIG. 10. In this case, the distance L2 described in the first embodiment is a distance with data (the values of the thickness and stiffness) regarding the recording sheet P not greater than the predetermined value. Such configuration is referred to as Aspect A.

That is, in Aspect A, with the thickness or stiffness of the recording sheet P greater than the predetermined value, the distance from the second position (the operating position) to the transfer portion (the secondary transfer nip N) is L2A. With the thickness or stiffness of the recording sheet P not greater than the predetermined value, the distance from the second position to the secondary transfer nip N is L2. The conveyance guide 161 moves such that the distance L2A is shorter than the distance L2.

With such configuration of Aspect A, the position of the leading edge 161a of the conveyance guide 161 varies depending on the thickness and the stiffness of the recording sheet P, thus allowing a changes in the distance from the entrance N1 of the nip N to the leading edge 161a according to the thickness and stiffness of the recording sheet P. With a thick and stiff recording sheet P, the distance from the entrance N1 to the leading edge 161a is shorter than the recording sheet P of a low thickness and weak in stiffness does, that is, L2 is greater than L2A. This configuration prevents toner electrostatically attracted onto the front surface 51a of the intermediate transfer belt 51 from scattering when the trailing edge Pb of the recording sheet P contacts the intermediate transfer belt 51, thus effectively preventing abnormal images from being generated due to transfer scattering caused by the impact. With the recording sheet P of low thickness and weak in stiffness, increasing the distance from the entrance N1 to the leading edge 161a locates the conveyance guide 161 away from the secondary transfer nip N. This configuration minimizes the contamination of the conveyance guide 161 due to toner scattering from the secondary transfer nip N.

Alternatively, a configuration below is applicable. Only with the data output from the recording-medium data output device 170 greater than a predetermined value, the first drive motor 168A and the second drive motor 168B move the leading edge 161a of the conveyance guide 161 from the first position of FIG. 3 to the second position of FIG. 4 when the trailing edge Pb of the recording sheet P approaches the leading edge 161a of the conveyance guide 161. In contrast, with the data (the values of the thickness and stiffness) output from the recording-medium data output device 170 not greater than the predetermined value, the leading edge 161a of the conveyance guide 161 is fixed at the first position of FIG. 3, which means that the position of the leading edge 161a is not changed. Such configuration is referred to as Aspect B.

That is, in Aspect B, only with the thickness or stiffness of the recording sheet P greater than the predetermined value, the drive device 163 moves the leading edge 161a of the conveyance guide 161 from the first position (the initial position) of FIG. 3 to the second position (the operating position) of FIG. 4 when the trailing edge Pb of the recording sheet P approaches the leading edge 161a of the conveyance guide 161.

With such configuration of Aspect B as well, abnormal images due to transfer scattering are effectively prevented from being generated, minimizing contamination of the conveyance guide 161 due to toner scattering from the secondary transfer nip N.

### Third Embodiment

In the first embodiment as illustrated in FIGS. 3 and 4, the support 162 slidably supports the conveyance guide 161. However, in some embodiments, another configuration is applicable. For example, a recording medium conveyance guide device 160A according to the present embodiment may be a single unit, in which a first drive motor 168A and a second drive motor 168B move a conveyance guide 161 and a support plate 162A those are fixed to each other.

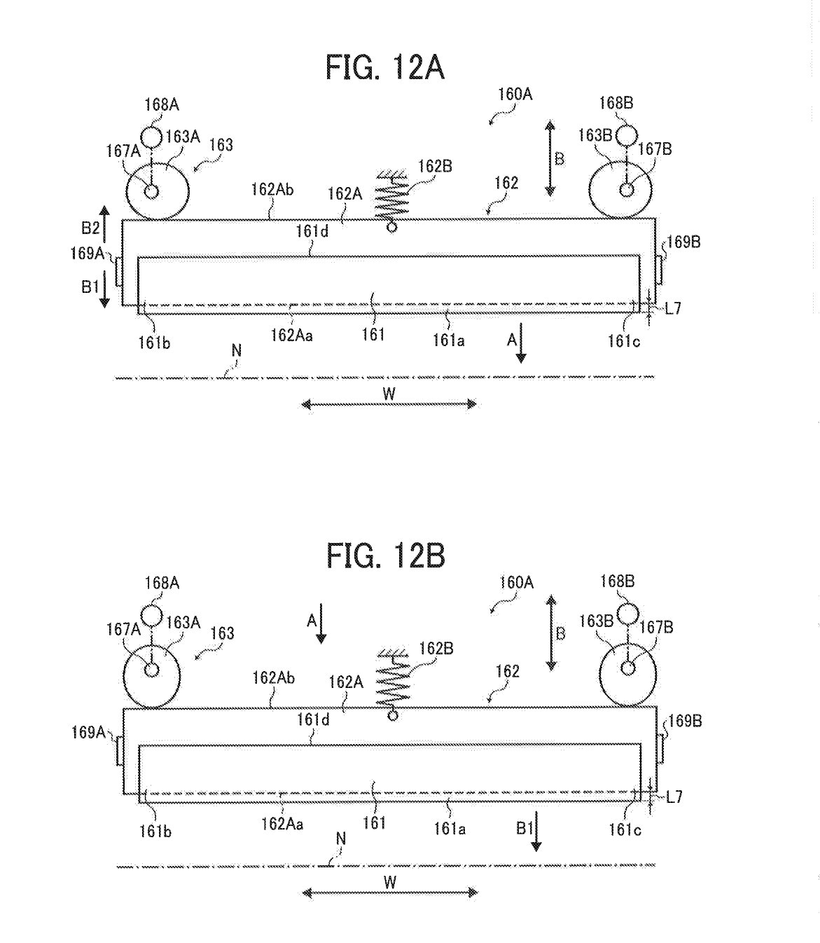

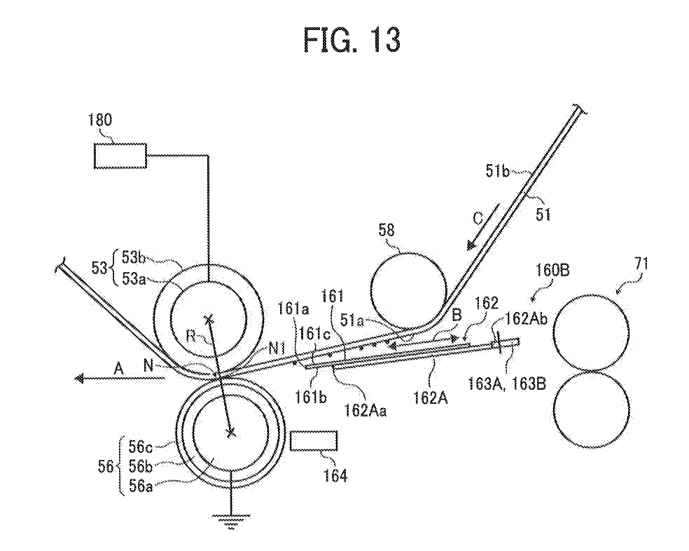

In this case, as illustrated in FIGS. 11, 12A, and 12B, the conveyance guide 161 is fixed to the support plate 162A with the leading edge 161a projecting beyond the leading edge 162Aa by a specific amount. The length of protrusion of the leading edge 161a from the leading edge 162Aa is referred to as free length L7. The rear edge 162Ab of the support plate 162A, which is upstream from the leading edge 162Aa in the recording-medium conveyance direction A, contacts the outer circumferential surfaces, i.e., cam surfaces of eccentric cams 163A and 163B. One end of a spring 162B is hooked to the rear edge 162Ab of the support plate, and the other end of the spring 162B is fixed onto the base of the apparatus 600. The first drive motor 168A and the second drive motor 168B drive the eccentric cams 163A and 163B to rotate, thereby moving the support plate 162A along the direction B.

That is, the conveyance guide 161 is at the initial position (the first position) before the recording medium detector 164 detects the trailing edge Pb of the recording sheet P. When the trailing edge Pb of the recording sheet P passes the conveyance guide 161, the first drive motor 168A and the second drive motor 168B are driven to rotate the eccentric cams 163A and 163B, thereby moving the conveyance guide 161 to the secondary transfer nip N.

This configuration delays the exit of the trailing edge Pb of the recording sheet P from the leading edge 161a of the conveyance guide 161, thereby shortening the length L6 (FIG. 9) of a contact portion between the intermediate transfer belt 51 and the trailing edge Pb of the recording sheet P as compared to the configuration, in which the support plate 162A does not slide and move to the secondary transfer nip N. That is, moving the support plate 162A toward the secondary transfer nip N extends the length of time it takes for the conveyance guide 161 to support the trailing edge Pb of the recording sheet P. This prevents an increase in the electrical field at the trailing edge Pb of the recording sheet P, reducing the voltage applied to the toner image electrostatically bored on the front surface 51a of the intermediate transfer belt 51, which prevents the occurrence of the electrical discharge. As a result, transfer scattering that scatters the toner image at the trailing edge Pb of the recording sheet P is prevented.

The present inventor has found that, with the conveyance guide 161 made of a material that flexes, such as Mylar (registered trademark), there is a possibility that the recording sheet P conveyed rapidly changes in behavior with a variation in free length L7.

In the present embodiment, without varying free length L7, which is the amount of protrusion of the leading edge 161a of the conveyance guide 161 from the support plate 162A that supports the conveyance guide 161 with the leading edge 161a projecting toward the secondary transfer nip N, the support plate 162A moves along the direction B to allow the leading edge 161a of the conveyance guide 161 to move between the first position and the second position, as illustrated in FIGS. 12A and 12B.

With such configuration, even with the conveyance guide 161 made of a material that flexes, such as Mylar (registered trademark), free length L7 does not vary, preventing the rapid change in behavior of the recording sheet P conveyed. Such configuration stabilizes the contact between the trailing edge Pb of the recording sheet P and the conveyance guide 161, preventing the occurrence of transfer scattering that scatters the toner image at the trailing edge Pb of the recording sheet P.

### Fourth Embodiment

In the embodiments described above, the conveyance guide 161 is disposed on the support plate 162A in such a manner that the amounts of protrusion (free length L7) of the leading edge 161a from the leading edge 162Aa of the support plate 162A are the same at between the first end 161b and the second end 161c in the width direction W. More specifically, in the embodiments described above, the leading edge 161a of the conveyance guide 161 is parallel to the leading edge 162Aa of the support plate 162A. The leading edge 161a and the leading edge 162Aa are disposed perpendicular to the recording-medium conveyance direction A.

In contrast, in a recording medium conveyance guide device 160B according to the present embodiment, the leading edge 161a of a conveyance guide 161 is oblique relative to the width direction W that is perpendicular to the recording-medium conveyance direction A, such that the first end 162b of the conveyance guide 161 in the width direction W is closer to the secondary transfer nip N than the second end 162c.

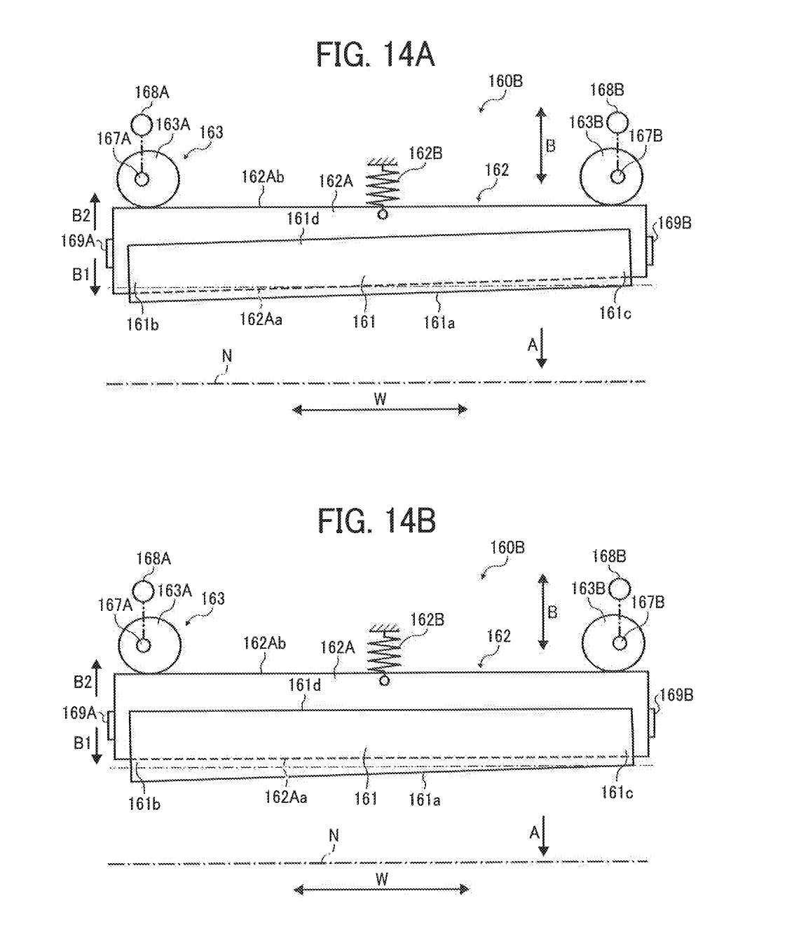

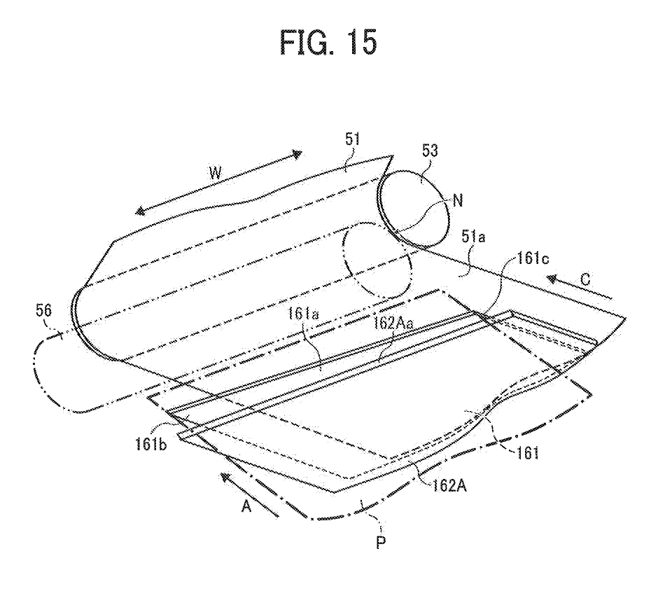

As one embodiment, in which the conveyance guide 161 or the support plate 162A is obliquely disposed, the first end 162b of the leading edge 161a is closer to the secondary transfer nip N than the second end 162c in the recording-medium conveyance direction A, with the leading edge 162Aa of the support plate 162A and the leading edge 161a of the conveyance guide 161 parallel to each other, as illustrated in FIG. 14A. That is, the support plate 162A is obliquely disposed such that the amounts of protrusion (free length L7) of the leading edge 161a from the leading edge 162Aa of the support plate 162A are the same at between the first end 161b and the second end 161c. Such arrangement delays the timing of contacting the recording sheet P with the conveyance guide 161 in the width direction W.

Alternatively, another configuration is applicable as illustrated in FIG. 14B, in which the support plate 162A is disposed with the leading edge 162A intersecting with the recording-medium conveyance direction A, and the conveyance guide 161 is disposed with the first end 161b projecting beyond the leading edge 162Aa of the support plate 162A by a greater amount than the second end 161c does. In the present embodiment, the conveyance guide 161 is disposed on the support plate 162A in such a manner that the leading edge 161a projects beyond the leading edge 162Aa of the support plate 162A by the same amount at between the first end 161b and the end 161c.

With such a configuration, in which the leading edge 161a of the conveyance guide 161 is obliquely disposed with the first end 162b of the leading edge 161a in the width direction W closer to the secondary transfer nip N than the second end 162c, the recording sheet P, which is conveyed contacting the bottom surface of the conveyance guide 161, gradually comes in contact with the front surface 51a of the intermediate transfer belt 51 from the second end 161c to the first end 161b. Such a configuration prevents the entirety of the recording sheet P from rapidly moving from the conveyance guide 161 to the intermediate transfer belt 51, reducing an improper transfer at the trailing edge Pb of the recording sheet P.

In the present embodiment, the controller 165 controls the first drive motor 168A and the second drive motor 168B to move the conveyance guide 161 or the support plate 162A immediately before the trailing edge Pb of the recording sheet P passes the second end 161c.

That is, when the configuration according to the fourth embodiment is applied to the configuration according to the first embodiment, the first drive motor 168A and the second drive motor 168B move the conveyance guide 161. When the configuration according to the fourth embodiment is applied to the configuration according to the third embodiment, the first drive motor 168A and the second drive motor 168B move the support plate 162A.

The present inventor has found that, it is ideal to move the conveyance guide 161 or the support plate 162A immediately before the trailing edge Pb of 3 mm or less in the recording sheet P exits the leading edge 161a of the conveyance guide 161, because such timing of projecting (moving) the conveyance guide 161 or the support plate 162A prevents an improper transfer at the trailing edge Pb of the recording sheet P.

It is preferable to eliminate or reduce a rapid change in length L5 (FIG. 8) of a contact portion between the front surface 51a of the intermediate transfer belt 51 and the recording sheet P, because such rapid change in length of a contact portion may cause a change in image density. However, with the leading edge 161a of the conveyance guide 161 oblique relative to the recording-medium conveyance direction A, the conveyance guide 161 or the support plate 162A is moved immediately before the trailing edge Pb of the recording sheet P exits the second end 161c that is projecting beyond the leading edge 161a by a smaller amount. This configuration eliminates or reduces a rapid change in length L5 of a contact portion between the front surface 51a of the intermediate transfer belt 51 and the recording sheet P, reducing a change in image density.

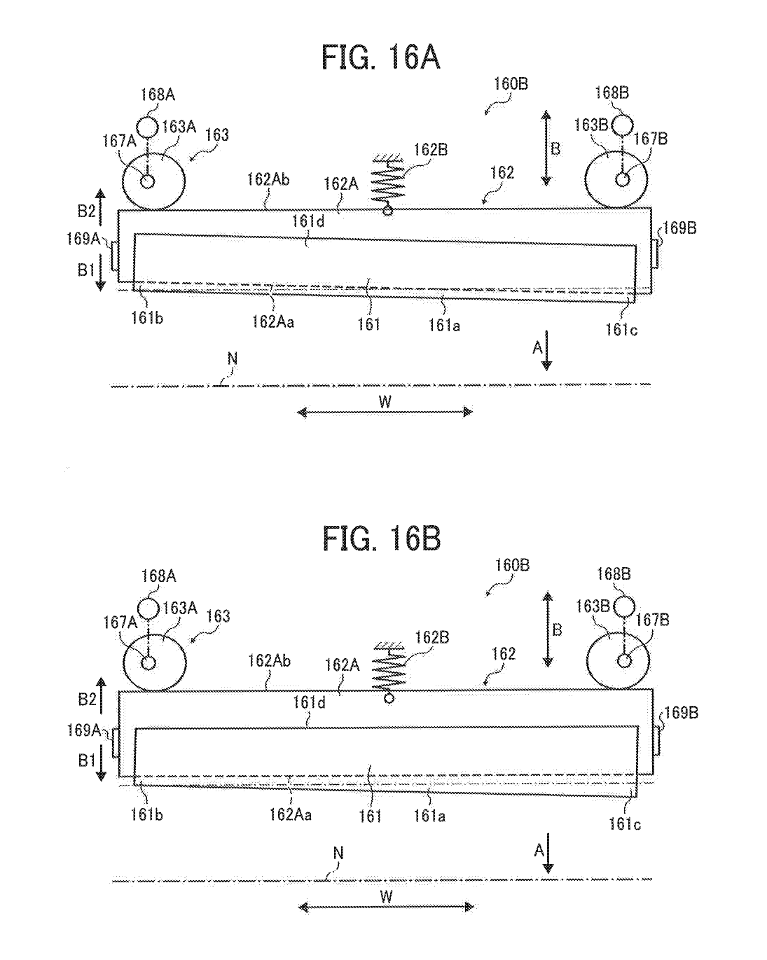

It should be noted that, in the present embodiment, the leading edge 161a of a conveyance guide 161 is obliquely disposed such that the first end 162b of the conveyance guide 161 in the width direction W is closer to the secondary transfer nip N than the second end 162c. However, the oblique direction is not limited to this configuration. For example, as illustrated in FIGS. 16A and 16B, the leading edge 161a is oblique such that the second end 161c of the conveyance guide 161 is closer to the secondary transfer nip N than the first end 161b. Thus, the recording sheet P having passed the leading edge 161a of the conveyance guide 161 does not simultaneously contact the intermediate transfer belt 51 at both first end 161b and second end 161c in the width direction W, but contacts the intermediate transfer belt 51 in different timings at between the first end 161b and the second end 161c.

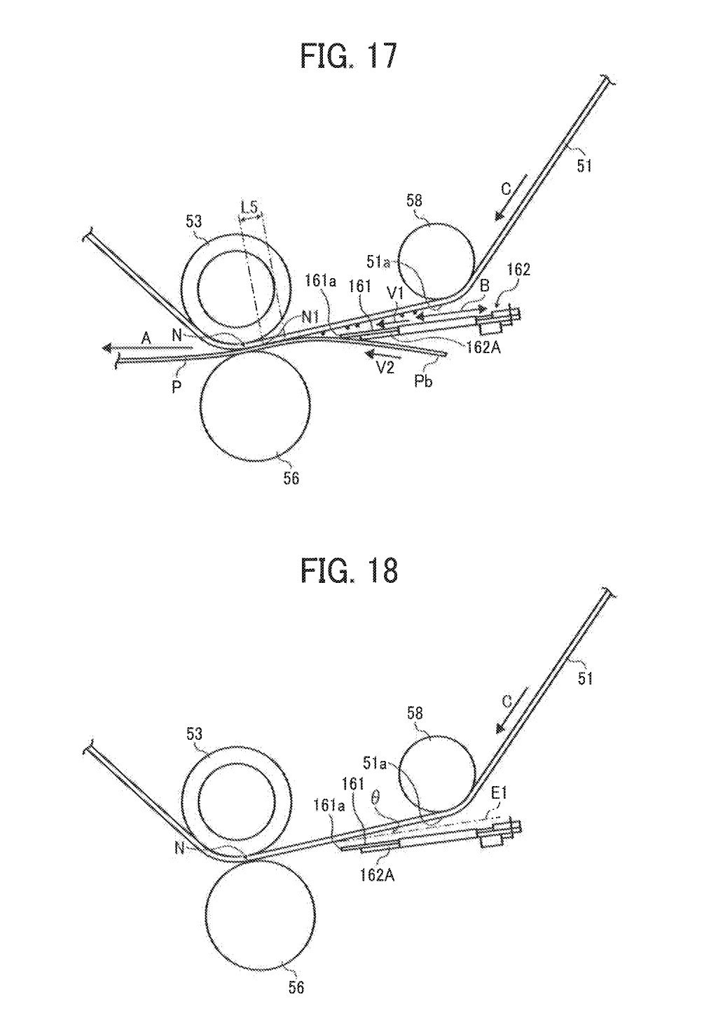

In the embodiments described above, the first drive motor 168A and the second drive motor 168B operate to move the conveyance guide 161 (including the configuration that moves the support plate 162A to move the conveyance guide 161) from the first position to the second position. The speed of movement of the conveyance guide 161 or the support plate 162A during this time is considered below. As illustrated in FIG. 17, the speed of movement of the conveyance guide 161 is V1, and the speed of conveyance of the recording sheet P as a recording medium is V2. Preferably, V1 is higher than or equal to V2.

The leading edge 161a of the conveyance guide 161 projects (moves) toward the secondary transfer nip N at a speed V1 higher than or equal to the speed of conveyance V2 of the recording sheet P set depending on the type and thickness of a sheet. That is, the speed V1 of movement depends on the speed V2 of conveyance. With this configuration, the difference between the speed V1 and the speed V2 is maintained within a certain range, preventing a rapid change in length L5 of a contact portion between the front surface 51a of the intermediate transfer belt 51 and the recording sheet P, thus reducing a change in image density.

Next, the positional relation between the front surface 51a of the intermediate transfer belt 51 and the conveyance guide 161 is considered below.

As illustrated in FIG. 8, the conveyance guide 161 is disposed facing the front surface 51a of the intermediate transfer belt 51 as a belt-shaped image bearer bearing an image to be transferred onto the recording sheet P. When the leading edge 161a of the conveyance guide is planar not curved, the leading edge 161a is disposed more toward the secondary transfer nip N as a transfer portion.

The present inventor has confirmed that, in such configuration, a favorable angle θ formed between the conveyance guide 161 and the front surface 51a of the intermediate transfer belt 51 is from 2° through 5°.

The angle θ is formed by a line E1 and the front surface 51a. The line El is parallel with the conveyance guide 161 as a guide plate, intersecting with the front surface 51a of the intermediate transfer belt 51.

That is, it is preferable that the conveyance guide 161 and the front surface Ma of the intermediate transfer belt 51 form an angle of 2° through 5°. In this case, the conveyance guide 161 is directed to a direction that the leading edge 161a approaches the front surface 51a of the intermediate transfer belt 51. The front surface 51a of the intermediate transfer belt 51 is a belt-shaped image bearing surface. Such a configuration reduces the degree of flexure of a stiff recording sheet P having run into the secondary transfer nip N, reducing the degree of force applied to the conveyance guide 161.

In the embodiments described above, the conveyance guide 161 is slided in a liner manner. Alternatively, another configuration is applicable. For example, the conveyance guide 161 moves along a curved line. Alternatively, in some embodiments, the drive device 163 slides and rotates by a predetermined amount while the leading edge 161a of the conveyance guide 161 moves from the first position to the second position.

In the embodiments described above, the first drive motor 168A and the second drive motor 168B are employed to move the conveyance guide 161 to the transfer portion (the secondary transfer nip N) along the direction B, with a spring 162B to bias the conveyance guide 161 in the direction B2. Alternatively, another configuration is applicable. For example, a solenoid may be employed to move the conveyance guide 161. Alternatively, without using the spring 162B, only the rotation of the eccentric cams 163A and 163B moves the conveyance guide 161 in directions to move close to and move away from the transfer portion (the secondary transfer nip N).

Although the embodiments of the present disclosure have been described above, the present disclosure is not limited to the embodiments described above, but a variety of modifications can naturally be made within the scope of the present disclosure.

The image forming apparatus 600 of the present disclosure is not limited to a color copier and a printer. The image forming apparatus 1000 includes, but is not limited to, an electrophotographic facsimile machine or a multi-functional system including at least two of a copier, a printer, a facsimile machine, and so forth.

In the embodiments described above, a description was provided of an image forming apparatus that employs the intermediate transfer method by which an image is transferred from the intermediate transfer belt 51 onto the recording sheet P. The configuration according to the present embodiments is applicable in an image forming apparatus that employs a direct transfer method in which an image is transferred from an image bearer, such as a photoconductive drum and a photoconductive belt, onto the recording sheet P.

In the embodiments described above, the secondary-transfer second roller 56 is used as a transfer device. Instead of the secondary-transfer second roller 56, a secondary transfer belt may be used as a belt-shaped transfer device. In addition, a transfer device that employs a charging method in which no transfer nip is formed may be used.

In the image forming apparatus according to the present embodiments described above, the recording sheet P passes through the secondary transfer nip N (the transfer portion) in a horizontal direction. Alternatively, in some embodiments, the image forming apparatus includes a configuration in which the recording sheet P passes through the transfer portion upward, downward, obliquely upward, or obliquely downward.

Although the embodiment of the present disclosure has been described above, the present disclosure is not limited to the foregoing embodiments, but a variety of modifications can naturally be made within the scope of the present disclosure.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. A recording medium conveyance guide device comprising:
a conveyance guide disposed upstream from a transfer nip, in which an image is transferred onto a recording medium, in a recording-medium conveyance direction, the conveyance guide to at least partially contact the recording medium; and
a drive device to move a leading edge of the conveyance guide from a first position to a second position closer to the transfer nip than the first position when a trailing edge of the recording medium approaches the leading edge of the conveyance guide.

2. The recording medium conveyance guide device according to claim 1, further comprising a support to slidably support the conveyance guide, wherein the drive device slides the conveyance guide relative to the support to move the leading edge of the conveyance guide between the first position and the second position.

3. The recording medium conveyance guide device according to claim 2, wherein the support includes:
a support plate extending toward the transfer nip to support the conveyance guide; and
a biasing device connected to the support plate and the conveyance guide to bias the conveyance guide toward a direction away from the transfer nip.

4. The recording medium conveyance guide device according to claim 3,
wherein a leading edge of the support plate is disposed upstream from the leading edge of the conveyance guide in the recording-medium conveyance direction, and
wherein the leading edge of the support plate contacts and guides the recording medium to the transfer nip as a guide.

5. The recording medium conveyance guide device according to claim 1,
wherein the drive device moves the conveyance guide such that a distance from the second position to the transfer nip when the recording medium has a thickness or stiffness greater than a predetermined value is shorter than a distance from the second position to the transfer nip when the recording medium has a thickness or stiffness not greater than the predetermined value.

6. The recording medium conveyance guide device according to claim 1, wherein only with the recording medium having a thickness or stiffness greater than a predetermined value, the drive device moves the leading edge of the conveyance guide from the first position to the second position when the trailing edge of the recording medium approaches the leading edge of the conveyance guide.

7. The recording medium conveyance guide device according to claim 1, further comprising:
a support plate to support the conveyance guide with the leading edge of the conveyance guide projecting beyond a leading edge of the support plate toward the transfer nip,
wherein the drive device slides the support plate to move the leading edge of the conveyance guide between the first position and the second position.

8. The recording medium conveyance guide device according to claim 1,
wherein the leading edge of the conveyance guide is oblique with a first end of the conveyance guide in a width direction perpendicular to the recording-medium conveyance direction being closer to the transfer nip than a second end of the conveyance guide in the width direction, and
wherein the drive device moves the conveyance guide or the support plate immediately before the trailing edge of the recording medium passes the second end.

9. The recording medium conveyance guide device according to claim 1,
wherein a speed of movement of the conveyance guide from the first position to the second position is higher than or equal to a speed of conveyance of the recording medium.

10. The recording medium conveyance guide device according to claim 1,
wherein the conveyance guide is disposed facing a belt-shaped image bearer bearing an image to be transferred onto the recording medium, and,
wherein the conveyance guide and a surface of the belt-shaped image bearer form an angle of from 2° through 5°.

11. A transfer device comprising the recording medium conveyance guide device according to claim 1.

12. An image forming apparatus comprising the transfer device according to claim 11.

13. The image forming apparatus according to claim 12, further comprising:
a belt-shaped image bearer to bear the image to be transferred onto the recording medium; and
a transfer device to contact the belt-shaped image bearer to form the transfer nip between the transfer device and the image bearer;
wherein a distance from the image bearer to the leading edge of the conveyance guide at the second position is shorter than a distance from the image bearer to the leading edge of the leading edge of the conveyance guide at the first position.
